(19) United States
(12) Patent Application Publication
(10) Pub. No.: US 2024/0393155 A1
(43) Pub. Date: Nov. 28, 2024

(54) METHOD FOR DETERMINING THE PROPORTION OF DISPERSE GAS PHASE IN LIQUID

(71) Applicant: Levitronix GmbH, Zürich (CH)

(72) Inventor: Maciej BOBER, Penzing (DE)

(21) Appl. No.: 18/714,081

(22) PCT Filed: Feb. 6, 2023
(86) PCT No.: PCT/EP2023/052780

§ 371 Date: May 28, 2024

(30) Foreign Application Priority Data
Feb. 7, 2022 (EP) 22155395.1

(51) Int. Cl. G01F 1/667; G01F 1/66; G01F 15/18

(52) U.S. Cl. CPC G01F 1/667; G01F 1/662; G01F 15/18

(57) ABSTRACT

A method includes providing an ultrasonic measuring device to determine a transit time difference between two measurement signals passing through the fluid in the pipe, emitting and receiving first and second measurement signals, transmitting the measurement signals to a storage and evaluation unit, determining an individual value for the transit time difference between the first and second measurement signals, determining a plurality of individual values for the transit time difference, determining a mean value for the transit time difference, determining a scattering parameter, which is characteristic for the scattering of the individual values around the mean value, providing a correlation between the mean value for the transit time difference and the change in the scattering parameter in dependence on the fraction of the disperse gas phase, and determination of the fraction of the disperse gas phase from the scattering parameter and the aforementioned correlation.

### CROSS-REFERENCE TO RELATED APPLICATION

This application is a U S. National Stage application of PCT/EP2023/052780, filed Feb. 6, 2023, which claims print to European Application No. 22155395.1, filed Feb. 7, 2022, the contents of which are hereby incorporated by reference.

### BACKGROUND

### Technical Field

The disclosure relates to method for determining the fraction of a disperse gas phase in a fluid flowing in a pipe in a flow direction by ultrasound, wherein a transit time difference between two measurement signals passing through the fluid in the pipe is determined by an ultrasound measuring device.

### Background Information

In process engineering, non-invasive methods are used for the examination of fluids or for the measurement of fluids which flow in pipes, for example in a flexible plastic tube. This is in particular the case for such highly pure or very sensitive fluids, where contact between the fluid and the measuring device should be avoided as far as possible, for example, so that the fluid is not contaminated. The pharmaceutical industry and the biotechnology industry are mentioned here as examples. Here, solutions and suspensions are frequently produced and conveyed that place very high demands on the purity and/or the integrity of the fluid. Frequently, such fluids must even be treated under sterile conditions.

### SUMMARY

It has been determined that the ultrasonic measurement technology in particular has proven its worth as a non-invasive method for measuring fluids flowing in pipes. Ultrasonic measuring devices for measurement on a fluid flowing in a pipe are used, for example, to determine the flow rate of the fluid through a pipe. Thereby, it is a known measure to design the measuring device as a clamping device in such a way that it can be clamped onto a flexible pipe or that the pipe is clamped by the measuring device. The pipe with the fluid flowing in it is then applied with ultrasonic signals. After passing through the pipe and the fluid, the ultrasonic signals are received by an ultrasonic transducer and the received signal is evaluated.

It is a known measure for the determination of the flow rate that the ultrasonic measuring device comprises at least two ultrasonic transducers, which are arranged laterally on opposite sides of the pipe in the operating state. The two ultrasonic transducers are arranged offset from each other with respect to the flow direction of the fluid and thereby aligned in such a way that the first ultrasonic transducer can receive a signal emitted from the second ultrasonic transducer, and the second ultrasonic transducer can receive a signal emitted from the first ultrasonic transducer. Due to the offset to each other, the two ultrasonic transducers are aligned in such a way that they each emit their ultrasonic signals obliquely to the flow direction of the fluid, whereby one ultrasonic transducer emits the signal obliquely with the direction of flow, while the other ultrasonic transducer emits the signal obliquely against the flow direction. Now, a measurement signal is emitted by the first ultrasonic transducer which is received by the second ultrasonic transducer, and then a measurement signal is emitted by the second ultrasonic transducer which is emitted by the first ultrasonic transducer.

The measurement signal emitted obliquely in the flow direction is accelerated in the flow and the measurement signal emitted obliquely against the flow direction is decelerated by the flow. The transit time difference of the two measurement signals is proportional to the flow velocity of the fluid, so that the flow rate through the flexible pipe can be determined from this transit time difference.

In addition to such ultrasonic methods which are based on the measurement of transit times or transit time differences, methods are also known in which the amplitude or frequency or the attenuation of the ultrasonic signals is determined. With these parameters and in particular also from combinations of these parameters, for example transit time and attenuation, it is possible to determine not only the flow rate but also other characteristics of the fluid, for example its viscosity or its optical density.

However, the fluid is very often not a single-phase fluid but a multi-phase system, for example a dispersion. A dispersion is characterized by the presence of non-dissolved components in another medium, the so-called dispersion medium. These non-dissolved components are designated as the disperse phase. Typically, the non-dissolved components are statistically distributed in the dispersion medium.

An important example of such a multi-phase system is a fluid, in particular a liquid, which contains non-dissolved gas bubbles as a disperse phase. It is often necessary to examine the fluid flowing in a pipe for the presence of gas bubbles. If, for example, a patient's blood is pumped through pipes, for example in the course of an operation, for example by using a heart-lung machine, it is extremely important to examine the blood flowing in the pipe for the presence of gas bubbles, such as air bubbles, because these could have life-threatening consequences.

For the detection of gas bubbles in the scope of an ultrasonic flow measurement, it has been proposed in EP 2 717 026 to determine in addition to the transit time of the ultrasonic signal but also its amplitude after passing through the fluid. A strong decrease or collapse of the amplitude is used as an indicator that gas bubbles exist in the fluid. With this amplitude-based measurement, however, only the qualitative statement that gas bubbles are present in the fluid can be made, a quantitative statement about the fraction of gas bubbles in the fluid is practically not possible. For example, this is due to the fact that many small gas bubbles can cause the same amplitude drop as one larger one, or that smaller gas bubbles flow in the acoustic shadow of a larger gas bubble and thus contribute nothing to the amplitude drop. The amplitude of the received ultrasonic signal also depends on many other factors, for example, the temperature of the medium, the properties of the ultrasonic transducers or the properties of the pipe or tube. For this reason, it is now common to use the amplitude of the received ultrasonic signal only for the qualitative statement whether air bubbles or gas bubbles are present in the fluid or not.

However, for many applications, it is desirable to be able to determine the fraction of gas bubbles or more generally of the disperse phase in a fluid, i.e., also to be able to make a reliable quantitative statement about the disperse phase.

As an example, automatic filling processes are mentioned here. In such filling processes, the weight is usually used as a reference. i.e., the filling is terminated as soon as the container to be filled has reached a predeterminable weight. For example, if a liquid which flows into the container to be filled contains a larger fraction of gas bubbles, e.g., air bubbles, in particular towards the end of the filling process, the volume belonging to the predetermined weight increases as a result. The air bubbles are more likely to collect at the top of the container. The average density of the liquid with the gas bubbles contained in it decreases. As a result, there is the risk that the container to be filled will overflow because the volume belonging to the predetermined weight has no place in the container. Therefore, the filling process is terminated too late and damages to the container and, in the worst case, destruction of the container can occur. This means danger for the operating personnel and the machines. Furthermore, economic losses can be the consequence. To prevent such consequences, very high safety margins are often provided, so that in many cases the processes would be stopped or interrupted prematurely. If the fraction of the disperse gas phase, in this case the air bubbles, could be determined reliably, these safety margins could be reduced and thus the process could be carried out more efficiently and economically.

The present disclosure is dedicated to this problem.

Starting from this state of the art, it is therefore an object of the disclosure to propose a method, with which the fraction of the disperse gas phase in a fluid flowing through a pipe can be reliably determined. This method is to be realizable by an ultrasonic measuring device.

Thus, the method shall allow a quantitative statement about the disperse gas phase in a flowing fluid based on an ultrasonic measurement.

The subject matter of the disclosure meeting this object is characterized by the features disclosed herein.

According to the disclosure, a method is thus proposed for determining the fraction of a disperse gas phase in a fluid flowing in a pipe in a flow direction by ultrasound, comprising the following steps:
a) Providing an ultrasonic measuring device which is designed to determine a transit time difference between two measurement signals passing through the fluid in the pipe,
b) Emitting and receiving a first measurement signal by the ultrasonic measuring device, wherein the first measurement signal is emitted with the flow direction,
c) Emitting and receiving a second measurement signal by the ultrasonic measuring device, wherein the second measurement signal is emitted against the flow direction.
d) Transmitting the measurement signals to a storage and evaluation unit,
e) Determining an individual value for the transit time difference between the first measurement signal and the second measurement signal,
f) Determining a plurality of individual values for the transit time difference by repeating steps b) to e),
g) Determining a mean value for the transit time difference from the individual values for the transit time difference,
h) Determining a scattering parameter, which is characteristic for the scattering of the individual values,
i) Providing a correlation between the mean value for the transit time difference and the change in the scattering parameter in dependence on the fraction of the disperse gas phase,
j) Determination of the fraction of the disperse gas phase from the scattering parameter and the aforementioned correlation,
wherein optionally the individual values for the transit time difference or a mean value over several individual values are transformed into individual values for the flow rate of the fluid or into a mean value for the flow rate, and steps h) and i) are carried out with the individual values for the flow rate or the mean value for the flow rate

The realization is thus essential for the disclosure that the fluctuations of the transit time difference (or the values for the flow rate determined therefrom) about the mean value of the transit time difference (or the mean value for the flow rate determined therefrom) for a constant mean value of the transit time difference (or the flow rate) depend in a very well reproducible manner on the fraction of the disperse phase in the fluid. Thus, the statistical fluctuations of the transit time difference (or the values for the flow rate determined therefrom), i.e., quasi the “noise” of the transit time difference (or the values for the flow rate determined therefrom) around the mean value of the transit time difference (or the values for the flow rate determined therefrom) can be used for a reliable determination of the fraction of the disperse gas phase, for example the fraction of gas bubbles, in the fluid.

In doing so, it is possible to obtain a quantitative statement about the disperse gas phase in the fluid based on ultrasonic flow measurements.

Here, it is a particular advantage of the method according to the disclosure that it is based on transit time measurements by ultrasound. Such measurements of the transit times are, at least to a very good approximation, independent of the amplitude of the respective received ultrasonic measurement signal, and are therefore influenced by considerably fewer factors than, for example, measurements of the amplitude of a received ultrasonic measurement signal.

It has also been shown that the determination of the fraction of the disperse gas phase based on the transit time difference of measurement signals leads to significantly more accurate and more reproducible results than, for example, those determinations in which the fraction of the disperse gas phase is determined by evaluating the amplitude of ultrasonic signals and then estimating the fraction of the disperse gas phase from the statistical fluctuations of the amplitude values.

For a given mean value of the transit time difference of measurement signals, the fraction of the disperse gas phase can be reliably determined from the statistical fluctuations of the transit time difference around this mean value.

In principle, all ultrasonic measuring devices are suitable for the method according to the disclosure, with which the transit time difference between two measurement signals can be determined, which pass through a fluid flowing in a pipe.

Preferably, for emitting and receiving the measurement signals, at least one first ultrasonic transducer is provided, which is arranged laterally on a first side of the pipe in the operating state, and at least one second ultrasonic transducer, which is arranged laterally on a second side of the pipe in the operating state, wherein the second side is opposite to the first side. The ultrasonic transducers are arranged and aligned in such a way that the first ultrasonic transducer can emit the first measurement signal obliquely to the flow direction of the fluid to the second ultrasonic transducer and can receive the second measurement signal emitted by the second ultrasonic transducer obliquely to the flow direction.

Furthermore, it is preferred that the flow rate of the fluid through the pipe is determined from the transit time differences between the first measurement signals and the second measurement signals.

Particularly preferably, the ultrasonic measuring device is designed as a clamping device, and the pipe is clamped in the ultrasonic measuring device. Such clamping devices are disclosed, for example, in EP 3 489 634 A1 or also in EP 3 816 590 A1. It is a particular advantage of the device disclosed in EP 3 816 590 A1 that the ultrasonic signals are emitted and received in several different measurement planes. In doing so, it is made possible, for example, that smaller gas bubbles in particular can be detected more reliably in the peripheral area of the measurement volume and also such gas bubbles that move in the shadow of other gas bubbles.

According to a preferred embodiment of the method according to the disclosure, the determination of the fraction of the disperse gas phase is updated at regular intervals or continuously.

The method according to the disclosure is also particularly suitable for increasing the accuracy of the measurement of the flow rate of the fluid through the pipe. For this purpose, for example, a corrected mean value for the flow rate can be determined with the aid of the fraction of the disperse gas phase. This corrected mean value then considers the influence of the disperse gas phase on the determination of the flow rate.

Preferably, the corrected mean value indicates the flow rate of the fluid without the disperse gas phase. This means that it can be determined on the basis of the fraction of the disperse gas phase what influence the disperse gas phase has on the individual values for the flow rate or on the mean value for the flow rate. Thus, for example, the corrected mean value for the flow rate can be determined, which indicates how large the flow rate of the fluid is without the disperse gas phase. Thus, the flow rate of the “pure” dispersion medium can be determined, which allows a significant increase in the accuracy of the flow rate measurement.

In principle, any parameter that is a measure of the fluctuations or scattering of the individual values of the transit time difference measurement (or the values for the flow rate) around the mean value of the transit time difference (or the flow rate) is suitable as a scattering parameter. Preferably, the scattering parameter is a statistical parameter that describes the statistical noise of the individual values around the mean value. For example, the scattering parameter is the variance of the individual values with respect to the mean value or the standard deviation of the individual values.

In a preferred embodiment of the method according to the disclosure, the change in the scattering parameter in dependence on the fraction of the disperse gas phase at a constant mean value for the transit time difference (or the flow rate) is described by a linear determination function.

Here, it is particularly preferred that the linear determination function is defined by two linear coefficients, wherein each linear coefficient is determined on the basis of a polynomial function whose variable is the mean value for the transit time difference (or the flow rate).

For the determination of the fraction of the disperse phase from the transit time difference measurements, it is also possible that the change in the scattering parameter in dependence on the fraction of the disperse gas phase at a constant mean value for the transit time difference is stored in a lookup table in the storage and evaluation unit.

In particular for lower flow velocities of the fluid through the pipe, it can be advantageous that the fraction of the disperse gas phase is first determined, and from this a modified fraction of the disperse gas phase is determined by applying a smoothing factor.

It is preferred that the smoothing factor is calculated with a polynomial function whose variable is the mean value for the transit time difference.

In a preferred application of the method according to the disclosure, the disperse gas phase includes gas bubbles.

Then, the fraction of the disperse gas phase is preferably the volume fraction of gas bubbles in a liquid.

Since the transit time difference between the first measurement signal and the second measurement signal is proportional to the flow velocity of the fluid in the pipe, any value of the transit time difference can be converted into a value for the flow rate in a very simple way. Therefore, it is also possible that each transit time difference is converted into a value for the flow rate of the fluid through the pipe, and the fraction of the disperse gas phase is determined by the values for the flow rate. However, this mere conversion does not change the fact that the determination of the fraction of the disperse gas phase is based on the transit time differences. If the transit time differences are first converted into values for the flow rate, the corresponding quantities or the corresponding relationship for the flow rate must of course also be used instead of the mean value for the transit time difference, the scattering parameter, and the relationship between the mean value for the transit time difference and the change in the scattering parameter in dependence on the disperse gas phase. This means that the individual values and/or the mean value for the transit time difference are converted into individual values and/or the mean value for the flow rate, the scattering parameter is determined accordingly for the flow rate values, and the relationship between the mean value for the transit time difference and the change in the scattering parameter in dependence on the fraction of the disperse gas phase is transformed into a relationship between the mean value for the flow rate and the change in the scattering parameter in dependence on the fraction of the disperse gas phase.

Furthermore, it is possible that an averaged individual value is first determined from a pre-determinable number of individual values, and that the statistical evaluation, i.e., in particular the determination of the scattering parameter, is then carried out on the basis of the averaged individual values. This substantially corresponds to a smoothing of the individual values before the statistical evaluation.

Further advantageous measures and embodiments of the disclosure are apparent from the dependent claims.

### BRIEF DESCRIPTION OF THE DRAWINGS

The disclosure will be explained in more detail hereinafter with reference to the drawings.

FIG. 1 illustrates a schematic representation of an ultrasonic measuring device for determining a transit time difference between two measuring signals passing through a fluid in a pipe,

FIG. 2 illustrates a perspective representation of an ultrasonic measuring device for determining the transit time difference, designed as a clamping device,

FIG. 3 illustrates a schematic representation for illustrating an embodiment of the method according to the disclosure.

FIG. 4 illustrates a diagram showing the correlation between a scattering parameter and the fraction of a disperse gas phase in a fluid, and

FIG. 5 illustrates FIG. 3, but for a variant of the embodiment.

### DETAILED DESCRIPTION

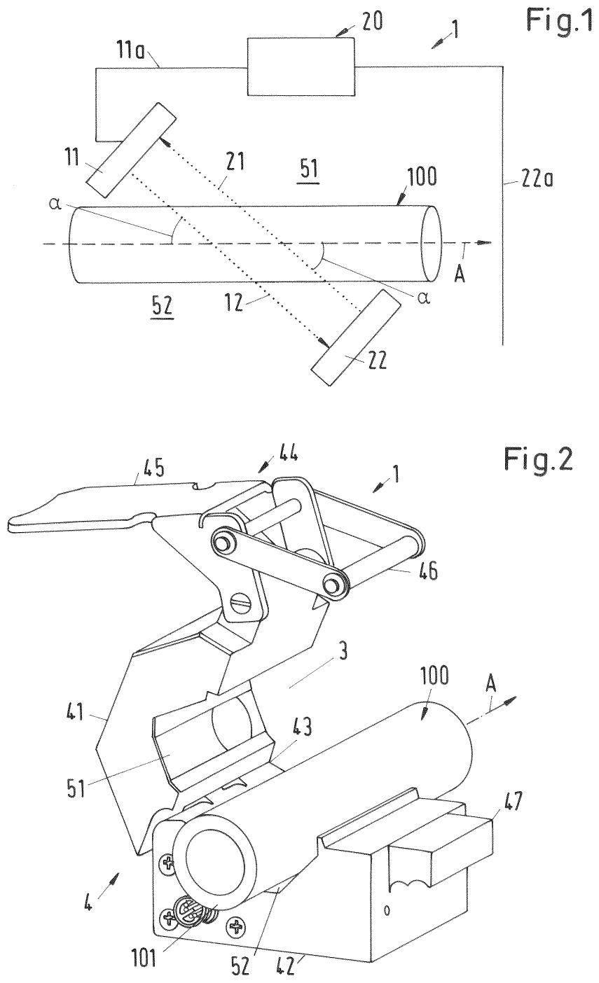

A method for determining the fraction of a disperse gas phase in a fluid flowing in a pipe 100 (FIG. 1) is proposed by the disclosure, in which method an ultrasonic measuring device 1 is used for determining a transit time difference between two measurement signals passing through the fluid in the pipe 100.

In the following description, it is referred to the application case with an exemplary character that the disperse gas phase consists of gas bubbles. Furthermore, reference is made to the example that the fluid is a liquid. In addition, the volume fraction of gas bubbles is considered as an example of the fraction of the disperse gas phase. In the following, the determination of the volume fraction of gas bubbles in a liquid, for example water or an aqueous solution, is considered as an example.

Of course, the disclosure is not limited to these examples, but also concerns other types of dispersions. In general, a dispersion is defined as a multiphase system in which non-dissolved components, quantities or objects are present in a medium. The non-dissolved components are usually designated as the disperse phase and the medium as the dispersion medium. In this case, the non-dissolved components of the disperse phase are usually statistically distributed in the dispersion medium.

In the method according to the disclosure, the dispersion medium is a fluid, i.e., a liquid or a gas, for example. The disperse phase is a disperse gas phase. i.e., the disperse phase is gaseous. The method according to the disclosure is particularly suitable for such applications in which the volume of the disperse gas phase is at most 40% of the total volume, i.e. the volume of the disperse gas phase and the volume of the dispersion medium.

By the term “fraction of the disperse gas phase” is meant that a quantitative determination of the amount or volume or mass of the disperse gas phase in the fluid is made, i.e., for example, the determination of a volume percentage or a mass percentage.

In principle, all ultrasonic measuring devices 1 with which the transit time difference between two measurement signals in a fluid flowing through a pipe 100 can be determined are suitable for the method according to the disclosure. Here, one measuring signal is emitted in the flow direction of the fluid and the other measuring signal is emitted against the flow direction. Such ultrasonic measuring devices 1 are also suitable, which themselves form the pipe 100 or a part of the pipe 100, i.e., for example so-called inline measuring devices, in particular such as those marketed by the applicant under the brand name LEVIFLOW LFS.

FIG. 1 shows in a schematic representation an ultrasonic measuring device 1 for determining the transit time difference between two measurement signals passing through a fluid flowing through a pipe. The pipe is designated with the reference sign 100. In the following, reference is made to the case, which is particularly important in practice, where the pipe 100 is a flexible pipe 100, i.e., a pipe 100 whose wall 101 (FIG. 2) can be deformed. The flexible pipe 100, for example, is a plastic tube made of silicone rubber or PVC. Of course, the pipe 100 can also be made of other materials, in particular a plastic or a rubber. Of course, the method according to the disclosure, is also suitable for rigid, i.e., non-flexible, pipes.

The fluid flows through the pipe 100 in a flow direction A. For emitting and receiving measurement signals 12, 21, which are ultrasonic signals, at least two ultrasonic transducers 11, 22 are provided, namely a first ultrasonic transducer 11 and a second ultrasonic transducer 22. In the operating state, the first ultrasonic transducer 11 is arranged laterally on a first side 51 of the pipe 100, and the second ultrasonic transducer 22 is arranged laterally on a second side 52 of the pipe 100, wherein the second side 52 is opposite to the first side 51. The ultrasonic transducers 11, 22 are arranged and aligned in such a way that the first ultrasonic transducer 11 can emit a first measurement signal 12 oblique to the flow direction A of the fluid to the second ultrasonic transducer 22 and can receive a second measurement signal 21 emitted by the second ultrasonic transducer 22 oblique to the flow direction A.

In FIG. 1, the measurement signals 12, 21 are each symbolically represented by dashed straight lines with an arrowhead. This is to be understood in such a way that the dashed line indicates in each case the main direction of propagation of the ultrasonic signal emitted by the corresponding ultrasonic transducer 11, 22 and the arrowhead indicates the direction. i.e., whether the respective ultrasonic signal is moving towards the respective ultrasonic transducer 11, 22. i.e., is received, or moves away from it, i.e., is emitted. The main direction of propagation is usually perpendicular to the surface of the piezoelectric element of the corresponding ultrasonic transducer 11 or 22. The main direction of propagation encloses with the flow direction A an angle α, which is different from 0° and from 90°.

In ultrasonic measuring devices 1, which are designed as inline measuring devices, it is often the case that this angle α is equal to 0° or equal to 180°, i.e., the measurement signals are emitted in such a way that their main direction of propagation is equal to the flow direction A or is directed exactly opposite to the flow direction A. For example, this can be realized with U-shaped or Z-shaped ultrasonic measuring devices.

In the ultrasonic measuring device 1 shown in FIG. 1, for example, the following procedure is used to determine the transit time difference. The first ultrasonic transducer 11 emits a first measurement signal 12, wherein the first measurement signal 12 is emitted obliquely at the angle α to the flow direction A and with the flow direction A, by which is meant that the main direction of propagation of the first measurement signal 12 also has a component in the flow direction A. The second ultrasonic transducer 22 emits a second measurement signal 21, wherein the second measurement signal 21 is emitted obliquely at the angle α to the flow direction A and against the flow direction A, by which is meant that the main direction of propagation of the second measurement signal 21 also has a component against the flow direction A.

The first measurement signal 12 is received by the second ultrasonic transducer 22 after passing through the fluid and is transmitted to a storage and evaluation unit 20 via a signal line 22a. The second measurement signal 21 is received by the first ultrasonic transducer 11 after passing through the fluid and is transmitted to the storage and evaluation unit 20 via a signal line 11a.

In the storage and evaluation unit 20, the transit time difference is determined between the first measurement signal 12, which was accelerated by the flowing fluid, and the second measurement signal 21, which was decelerated by the flowing fluid. This transit time difference between the first measurement signal 12 and the second measurement signal 21 is directly dependent on the flow velocity of the fluid in the pipe 100. Thus, the flow velocity and thus also the flow rate of the fluid through the pipe 100 can also be determined from the transit time difference, for example.

It is also often the case that at least four ultrasonic transducers 11, 22 are provided in the ultrasonic measuring device 1 for the respective emission and reception of ultrasonic signals, namely at least two of the first ultrasonic transducers 11, which are arranged laterally on the first side 51, and at least two of the second ultrasonic transducers 22, which are arranged laterally on the second side 52. The ultrasonic transducers 11, 22 are then arranged and aligned in such a way that in each case one of the first ultrasonic transducers 11 can emit a first measurement signal 12 obliquely to and with the flow direction A to one of the second ultrasonic transducers 22, and can receive a second measurement signal 21 emitted by this second ultrasonic transducer 22 obliquely to and against the flow direction A. For example, the four ultrasonic transducers 11, 12 are then arranged in the form of an X. Such an arrangement of the ultrasonic transducers 11, 22 is disclosed, for example, in EP 3 489 634 A1. In this arrangement with four ultrasonic transducers, it is advantageous that two mutually independent measurements are made both in the flow direction A and against the flow direction A, thus significantly increasing the accuracy and reliability of the determination of the flow rate for example.

Particularly preferably, the ultrasonic measuring device t is designed as a clamping device such that the pipe 100 can be clamped in the ultrasonic measuring device 1. In a perspective representation, FIG. 2 shows an embodiment of an ultrasonic measuring device 1 for determining the transit time difference between two measurement signals which is designed as a clamping device.

The ultrasonic measuring device 1 comprises a housing 4. The ultrasonic measuring device 1 is designed as a clamping device for a clamping connection with the pipe 100, i.e., the housing 4 of the ultrasonic measuring device 1 can be clamped onto the pipe 100 in such a way that the pipe 100 is fixed with respect to the housing 4. The principal design of the ultrasonic measuring device 1 with the housing 4 is known per se, for example, from EP 3 489 634 A1. In EP 3 816 590 A1, an ultrasonic measuring device 1 is also disclosed which is designed as a clamping device for a detachable attachment to the pipe 100 and which is suitable for the method according to the disclosure.

The housing 4 is designed as a closable housing 4 and comprises a first housing part 41 and a second housing part 42, which are connected to each other in an articulated manner via a joint 43. FIG. 2 shows the housing 4 in the open state. The housing 4 further has a continuous central receptacle 3, which extends through the entire housing 4 and serves to receive the pipe 100. The longitudinal extension of the central receptacle 3 defines the flow direction A in which the fluid flows through the pipe 100 or the housing 4.

The housing 4 further has a closing mechanism 44 to close the housing 4 and thus to clamp the pipe 100 in the central receptacle 3. The closing mechanism 44 is arranged here on the first housing part 41 and comprises a bracket 46 and a folding strap 45 for tensioning the bracket 46. The pipe 100 is inserted into the central receptacle 3, then the two housing parts 41, 42 are folded together, i.e., the first housing part 41 is folded over the pipe 100. The bracket 46 is engaged with a projection 47 on the second housing part 42 and the two housing parts 41, 42 are tensioned together by actuating the strap 45. The housing 4 is then in its closed state, in which the pipe 100 is clamped in the central receptacle 3 and is thus fixed with respect to the housing 4.

In the closed state of the housing 1, the pipe 100 is thus fixed between the first side 51 and the second side 52, which are opposite each other with respect to the central receptacle 3.

A marking element (not shown) can also be provided on the housing 4, for example an arrow, which defines the flow direction in which the fluid is to flow through the ultrasonic measuring device 1.

The central receptacle 3 is preferably designed in such a way that it has a substantially rectangular, in particular a square cross-section perpendicular to the flow direction A in the closed state of the housing 4. This has the advantage that ultrasonic measurement signals, which are applied to the pipe 100, hit planar, i.e., not curved surfaces, which greatly simplifies the detection and evaluation of the measurement signals 12, 21 and increases the accuracy of the measurement.

Embodiments are also known in which the central receptacle is designed in such a way that it has a different polygonal cross-section, for example a hexagonal cross-section, perpendicular to the flow direction A in the closed state of the housing. Furthermore, embodiments are known in which this cross-section is circular or oval. In such embodiments, acoustic lenses are then often used to emit and/or to receive the measurement signals.

The ultrasonic transducers 11, 22, which are not represented in FIG. 2, are provided in the housing 4, namely on the first side 51 and on the second side 52, respectively. The first ultrasonic transducer(s) 11 is/are arranged on the first side 51, and the second ultrasonic transducer(s) 22 is/are arranged on the second side 52.

Each of the ultrasonic transducers 11, 22 is signal-connected in each case to the storage and evaluation unit 20 via one of the signal lines 11a, 22a (FIG. 1). The signal lines 11a, 22a and the storage and evaluation unit 20 are not represented in FIG. 2. Via the respective signal line 11a, 22a, the ultrasonic transducers 11, 22 are actuated to emit ultrasonic signals, and transmit the respectively received measurement signals 12, 21 to the storage and evaluation unit 20. The received measurement signals 12 and 21 are analyzed in the storage and evaluation unit 20, and the transit time difference between one of the first measurement signals 11 and one of the second measurement signals 21 is determined in each case. Furthermore, it is possible to determine the flow rate of the fluid through the pipe 100 from the determined transit time differences.

The ultrasonic transducers 11, 22 can be designed in any manner known per se, in particular as piezoelectric transducers. Typically, the frequency of the ultrasonic signals is in the megahertz range, for example in the range of 1 MHz to 30 MHz.

The preceding description of the ultrasonic measuring devices 1 is to be understood only as an example. Any ultrasonic measuring device which is designed or suitable for determining the transit time difference between a measuring signal emitted with the flow direction A and a measuring signal emitted against the flow direction A is suitable for the method according to the disclosure.

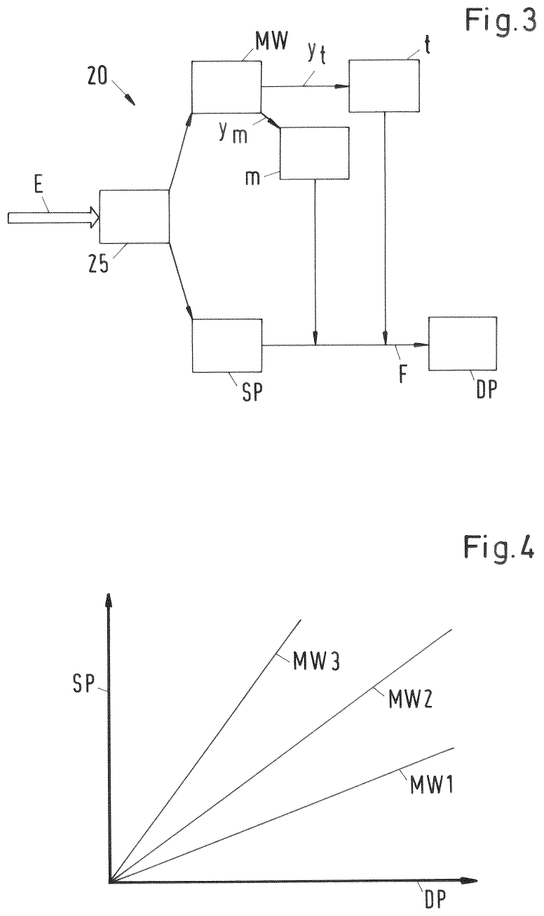

In a schematic representation, FIG. 3 illustrates an embodiment of a method according to the disclosure for determining the fraction of a disperse gas phase, which in this example consists of gas bubbles, in the fluid, which here is a liquid, wherein the fluid flows through the pipe 100.

A plurality of individual values for the transit time difference between a first measurement signal 12 and a second measurement signal 21 is determined in each case with the aid of the ultrasonic measuring device 1. These individual values are represented in FIG. 3 by the arrow with the reference sign E. Each individual value E is stored in a storage module 25 of the storage and evaluation unit 20. For example, the storage module 25 is designed as a FIFO storage (FIFO: First in-First out). The stored individual values E are collected in the storage module 25 and evaluated by an analysis procedure. The analysis procedure preferably uses statistical or stochastic methods to determine the fraction of the disperse phase, in this case the gas bubbles, in the fluid from the plurality of individual values E, as will be described in detail below.

Preferably, the determination of the fraction of the disperse phase is updated at regular intervals or continuously. Here, the term “continuously updated” means that with each new individual value E for the transit time difference, which is transmitted to the storage module, the evaluation is carried out again and thus, the determination of the fraction of the disperse phase is updated.

A mean value MW for the transit time difference is determined from the individual values E for the transit time difference. Preferably, the mean value MW is the statistical mean value MW or the arithmetic mean. i.e., the sum of n individual values E divided by the number n of individual values, wherein n is a natural number.

It is a substantial realization for the disclosure that the fluctuations of the individual values E around the mean value MW for a constant mean value MW depend in a very well reproducible way on the fraction of the disperse gas phase in the fluid. The statistical fluctuations of the individual values E around the mean value MW, i.e., the “noise” of the transit time difference (or also of the flow rate) around the mean value MW can thus be used for a reliable determination of the fraction of the disperse gas phase in the fluid.

Therefore, a scattering parameter SP is further determined from the individual values E for the flow rate, which is characteristic for the scattering of the individual values E around the mean value MW For example, the variance of the individual values E. or the empirical variance or the standard deviation or the empirical standard deviation of the individual values E from the mean value MW are suitable as the scattering parameter. Usually, the standard deviation is the square root of the variance. The (empirical) variance is the sum of the squared deviation of the n individual values E from the mean value MW divided by the number n of the individual values E or divided by the number (n−1) of degrees of freedom. Here, n is any natural number that indicates the number of the individual values E.

It is also possible to determine an averaged single value from a pre-determinable number of single values E and then to use these averaged single values for further analysis, i.e. in particular also for determining the mean value MW.

In a preferred embodiment, the variance SP defined as follows is used as the scattering parameter SP:

$$\\ SP = \frac{1}{( n - 1 )} {\sum }_{i = 1}^{n} {( {E}_{i} - MW )}^{2}$$

wherein Eᵢ designates the i-th individual value E (or the i-th averaged individual value) and n the number of the individual values E. Of course, the square root of the variance SP can also be used as a scattering parameter. This is usually referred to as the (empirical) standard deviation.

For a constant mean value MW of the transit time difference (or also of the flow rate), the change in the scattering parameter SP (i.e., the variance SP in this case) in dependence on the fraction of the disperse gas phase is described by a linear determination function F, which is a linear correlation of the following form:

$$\\ SP = m \cdot DP + t$$

wherein DP indicates the fraction of the disperse gas phase in the fluid, i.e., for example, the volume fraction of gas bubbles in the fluid in this case, and wherein m and t are two linear coefficients by which, for a given and constant mean value MW, the linear determination function F is determined. The determination of the linear coefficients m and t for a constant mean value MW will be discussed later.

Thus, the fraction of the disperse gas phase DP can be calculated with the aid of the linear determination function F as follows:

$$\\ DP = \frac{( SP - t )}{m}$$

As represented in FIG. 3, the mean value MW and the scattering parameter SP, in this case the variance SP, are determined from the individual values E, which are stored in the storage module 25. The two linear coefficients m and t are determined for the specific mean value MW. Thus, the linear determination function F is known for this specific mean value MW and thus the change in the scattering parameter SP in dependence on the fraction of the disperse gas phase DP. The fraction of the disperse phase DP can then be calculated as DP=(SP−t)/m.

Thus, the method according to the disclosure enables a quantitative statement about the disperse gas phase in the fluid.

The two linear coefficients m and t, which define the linear determination function F for a predeterminable and constant mean value MW, can, for example, be stored in a lookup table in the storage and evaluation unit 20 for different mean values MW. It is also possible to describe the linear coefficients m, t each by a functional correlation whose variable is the mean value MW of the. For each of the linear coefficients m, t, this functional correlation can be in each case a polynomial function, whose variable is the mean value MW.

Preferably, the linear coefficients m, t for the respective ultrasonic measuring device 1 are determined empirically or metrologically, for example by calibration measurements. For this purpose, this can be done as follows.

By the ultrasonic measuring device 1, the mean value MW for the transit time difference and the scattering parameter SP, i.e., here the variance SP, is measured in each case on a calibration fluid for different fractions of the disperse gas phase DP. The calibration fluid has a predeterminable fraction of the disperse phase DP. For example, this can be realized in such a way that a predeterminable volume fraction of a gas. e.g. air, is mixed to the liquid, e.g. water, flowing in the pipe 100. The mean value MW of the transit time difference and the variance SP. i.e., the scattering of the individual values E around the mean value MW is determined on this fluid, for example water with the gas bubbles contained therein, by the ultrasonic measuring device 1. With the volume fraction of the gas kept constant, the flow rate is then increased in several steps, for example from zero to a value of 10 liters per minute. In each case, the mean value MW and the variance SP are determined. This calibration measurement is repeated for different values of the fraction of the disperse gas phase DP, i.e., here of the gas bubbles, for example for volume fractions of the gas bubbles of 0%, 0.5%, 3% and 6%, to name just one example.

A set of curves is obtained from these calibration measurements, as represented with exemplary character in the diagram in FIG. 4. The fraction of the disperse phase DP, i.e., here the volume fraction of the gas bubbles in the liquid, is plotted on the horizontal axis, and the scattering parameter SP, i.e., here the variance, is plotted on the vertical axis. Three curves MW1, MW2, MW3 are represented in FIG. 4. Each of the curves MW1, MW2 and MW3 belongs to a constant mean value MW of the transit time difference. The curve MW1 belongs to the smallest value of the constant mean MW for the transit time difference, the curve MW3 belongs to the largest mean MW for the transit time difference, and the curve MW2 belongs to a middle value of the transit time difference. It can be well recognized that for a constant mean MW of the transit time difference, the correlation between the variance SP and the fraction of the disperse phase DP is, to a very good approximation, a linear correlation, which consequently can be described by the linear determinant function F:

$$\\ SP = m \cdot DP + t$$

In practice, it is often advantageous to determine considerably more than the three curves MW1, MW2, MW3 represented as examples in FIG. 4, i.e., to determine the correlation between the scattering parameter SP (i.e., here the variance SP) and the fraction of the disperse phase DP, i.e., here the volume fraction of the gas bubbles, for a larger number of respective constant flow rates—and thus constant transit time differences. For example, this correlation can be determined for twenty or even more respective constant mean values MW of the transit time difference or—which is analogously the same—of the flow rate.

A value for each of the two linear coefficients m and t can then be determined in each case from each of the curves MW1. MW2, MW3 and, if necessary, other curves not represented in FIG. 4. In the ideal case, it would be expected that each of the curves MW1. MW2, MW3 passes through the zero point of the coordinate system. i.e., the zero value for the scattering parameter SP belongs to the fraction of the disperse phase DP of zero. However, it has been shown in practice that the determination of the fraction of the disperse phase DP becomes more accurate if a value other than zero is allowed for the linear coefficient.

The totality of the linear coefficients m is now approximated by a polynomial function whose variable is the mean value MW for the transit time difference. Furthermore, the totality of the linear coefficients t is approximated by a polynomial function whose variable is the mean value MW for the transit time difference. Of course, other functions are also suitable for this approximation.

In the embodiment described here, a fourth-degree polynomial is used in each case for the determination of each of the linear coefficients m, t. Thus, the linear coefficients m, t are approximated on the basis of the following polynomial functions:

$$\\ {y}_{m} = {a}_{1} {MW}^{{}_{} {}_{} 4} + {a}_{2} {MW}^{{}_{} {}_{} 3} + {a}_{3} {MW}^{{}_{} {}_{} 2} + {a}_{4} MW + {a}_{5}$$

$$\\ {y}_{t} = {b}_{1} {MW}^{{}_{} {}_{} 4} + {b}_{2} {MW}^{{}_{} {}_{} 3} + {b}_{3} {MW}^{{}_{} {}_{} 2} + {b}_{4} MW + {b}_{5}$$

with the development coefficients a₁, a₂, a₃, a₄, a₅ and b₁, b₂, b₃, b₄, b₅, which usually depend on the specific ultrasonic measuring device 1 or the geometry of the pipe 100, for example its outer and/or inner diameter.

Of course, the linear coefficients m, t can also be described by polynomial functions of a different degree. Furthermore, it is possible to use two polynomials which have a different degree for the determination of the linear coefficient m and for the determination of the linear coefficient t.

Then, with the aid of the polynomial functions yₘ and yₜ, the associated linear coefficients m, t can then be determined for each value of the mean value MW of the transit time difference, as also represented in FIG. 3, with which the linear determination function F can then be calculated in each case.

Thus, for each mean value MW of the transit time difference between the first measurement signal 12 and the second measurement signal 21, the fraction of the disperse phase DP in the fluid flowing in pipe 100 can be determined from the scattering parameter SP.

The reaction time of the entire system with the ultrasonic measuring device 1 and the pipe 100 through which the fluid flows can be influenced in particular by the design of the storage module 25. The size or the storage capacity of the storage module 25, which is designed, for example, as a FIFO storage, together with the measuring frequency with which the individual values E are measured, influences the reaction time of the entire system, because usually a plurality of individual values E are first collected in the storage module 25 in order to determine the mean value MW and the scattering parameter SP from them.

If a short reaction time is desired in an application, it is advantageous to design the storage module 25 with a small capacity. However, if greater stability of the determination is important in an application, it is advantageous to design the storage module 25 with a larger capacity.

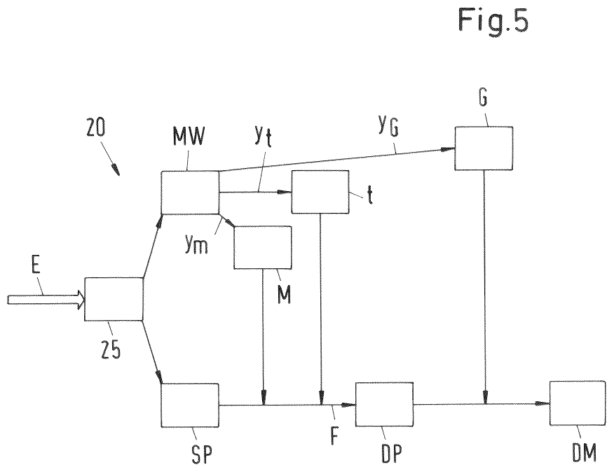

FIG. 5 shows a variant of the embodiment described above in a representation analogous to FIG. 3. In the following, only the differences of the variant compared to the embodiment according to FIG. 3 will be discussed. The same components or features equivalent in function are designated with the same reference signs as in the embodiment. It is understood that all the previous explanations also apply in the same way or in an analogously same way to the variant according to FIG. 5.

In the variant represented in FIG. 5, the fraction of the disperse phase DP is first determined, for example as described above. From this fraction of the disperse phase DP, a modified fraction of the disperse phase DM is then determined by applying a smoothing factor G.

In practice, it has been shown that for some applications, and in particular for small values for the mean value MW of the transit time difference and thus for small values of the flow rate through the pipe 100, the determination of the fraction of the disperse phase DP can be improved by applying the smoothing factor G to the determined value for the fraction of the disperse phase DP. Preferably, the modified fraction of the disperse phase DM is obtained by multiplying the fraction of the disperse phase DP by the smoothing factor G. Thus, it is.

$$\\ DM = G \cdot DP$$

For example, by the smoothing factor G it can be considered that in the case of weak flows, i.e., at small mean values MW for the transit time difference or the flow rate, the statistical character of the distribution of the gas bubbles as a disperse phase is at least partially lost, for example due to buoyancy or due to the flow conditions. In practice, it has been shown that the application of the smoothing factor G can be advantageous in particular when the flow through the pipe 100 is less than five times the critical Reynolds number.

The determination of the smoothing factor G is also carried out on the basis of such curves MW1, MW2, MW3, as represented in FIG. 4, which thus depict in each case for a constant mean value MW of the transit time difference the change of the scattering parameter SP, here as the variance SP, in dependence on the fraction of the disperse gas phase DP. For the calculation of the smoothing factor G, for example, a polynomial function can be used, e.g., a polynomial function y_{G} of the sixth degree with

$$\\ {y}_{G} = {c}_{1} {MW}^{{}_{} {}_{} 6} + {c}_{2} {MW}^{{}_{} {}_{} 5} + {c}_{3} {MW}^{{}_{} {}_{} 4} + {c}_{4} {MW}^{{}_{} {}_{} 3} + {c}_{5} {MW}^{{}_{} {}_{} 2} + {c}_{6} MW + {c}_{7}$$

with the development coefficients c₁, c₂, c₃, c₄, c₅, c₆, c₇, which usually depend on the specific ultrasonic measuring device 1 or the geometry of the pipe 100, for example its outer and/or inner diameter.

After the development coefficients c₁ to c₇ have been determined, the smoothing factor G for a specific mean value MWs of the transit time difference is obtained by calculating the function y_{G} at this point MWs. It is thus

$$\\ G ( {MW}_{s} ) = {y}_{G} ( {MW}_{S} )$$

Depending on the specific application, other function types can also be used as a polynomial function for the calculation of the smoothing factor, for example a hyperbola of the form:

$$\\ {y}_{G} = 1 + \frac{1}{{d}_{1} \cdot MW}$$

With the coefficient di, which is then determined on the basis of curves such as those represented in FIG. 4.

In the variant represented in FIG. 5, the smoothing factor G is thus additionally determined, and the calculated fraction of the disperse gas phase DP (in this case the fraction of gas bubbles) is multiplied by the smoothing factor G to obtain the modified fraction of the disperse phase DM in this way, which is a quantitative measure of how much of the fluid consists of the disperse phase, in this case how large the volume fraction of gas bubbles in the liquid is.

Thus, with the method according to the disclosure, a precise quantitative information can be determined about the fraction of the disperse phase DP, DM, i.e., for example about the gas fraction in a fluid, e.g., a liquid. This information can be used to expand or improve processes. Just like the increase in accuracy, new possibilities for automation open up. Examples are mentioned here.

For example, if a gas phase, i.e., for example gas bubbles, cannot be avoided during a decanting process of a fluid medium, e.g., a liquid, but the quantity of the decanted medium plays a role, the quantitative gas fraction can be calculated out of the decanted volume.

Flowmeters known per se from the state of the art often also offer a so-called volume counter. Here, the volume conveyed is calculated on the basis of the time and the flow rate. In the event of an error, for example if the presence of gas bubbles is detected during the measurement, at best a message appears indicating that bubbles were detected during the measurement How much the volume determined by the volume counter deviates from the actual volume, or how many gas bubbles were detected, remains unknown with these flowmeters.

With the method according to the disclosure, it can be realized that the system comprising the flowmeter itself performs a correction due to the now possible quantitative determination of the gas fraction in order to determine the actual volume, i.e., the volume without the fraction of gas bubbles.

For this purpose, for example, a corrected mean value for the flow rate of the fluid through the pipe 100 can be determined with the aid of the fraction of the disperse phase. i.e., in this case the gas bubbles. This corrected mean value then considers the influence of the disperse phase, i.e., in this case the gas bubbles, on the determination of the flow rate. From this corrected mean value for the flow rate, the volume of the pure liquid, i.e., without the volume of the gas bubbles, can then be determined.

For example, if it is necessary in a process that a predeterminable target volume of a medium is reached, the fraction of the disperse phase. e.g., of the gas bubbles, which of course should not contribute to the predetermined target volume, can be determined quantitatively with the method according to the disclosure. By appropriate corrections, for example a feedback to a pump or a valve or a control unit and open loop control unit, the process can then continue to run until the predeterminable target volume is actually reached.

As already mentioned, the method according to the disclosure can be carried out with all ultrasonic measuring devices 1 which are suitable for determining the flow rate of a fluid.

Since the method according to the disclosure makes it possible to determine quantitative information about a disperse phase in a fluid, it can also be used, for example, for threshold switches, limit switches or detectors, and in particular also in combination with already existing measurement or analysis technology.

In a non-exhaustive list, a number of applications are mentioned for which the method according to the disclosure is particularly suitable:
for monitoring the purity of liquid or gaseous end products or drugs in the pharmaceutical industry.
for monitoring the air supply to clean rooms, for example in the semiconductor industry.
for controlling during filling processes for end products, for example in the food industry or in the biotechnology industry,
for monitoring in medical technology when returning blood to the patient to prevent embolisms, for example when using a heart-lung machine,
in the automotive industry, for example for fuel monitors or for monitoring brake fluids.
for monitoring or measuring the degree of cavitation in pump technology.

1. A method for determining a fraction of a disperse gas phase in a fluid flowing in a pipe in a flow direction by means of ultrasound, comprising:
a) providing an ultrasonic measuring device to determine a transit time difference between two measurement signals passing through the fluid in the pipe;
b) emitting and receiving a first measurement signal by the ultrasonic measuring device, the first measurement signal emitted with the flow direction;
c) emitting and receiving a second measurement signal by the ultrasonic measuring device, the second measurement signal emitted against the flow direction;
d) transmitting the measurement signals to a storage and evaluation unit;
e) determining an individual value for the transit time difference between the first measurement signal and the second measurement signal;
f) determining a plurality of individual values for the transit time difference by repeating steps b) to e);
g) determining a mean value for the transit time difference from the individual values for the transit time difference;
h) determining a scattering parameter, which is characteristic for the scattering of the individual values;
i) providing a correlation between the mean value for the transit time difference and the change in the scattering parameter in dependence on the fraction of the disperse gas phase; and
j) determination of the fraction of the disperse gas phase from the scattering parameter and the aforementioned correlation.

2. The method according to claim 1, wherein, for the emitting and receiving the first and second measurement signals a first ultrasonic transducer is provided, which is arranged laterally on a first side of the pipe in an operating state, and at least a second ultrasonic transducer, which is arranged laterally on a second side of the pipe in the operating state, the second side is opposite to the first side, the first and second ultrasonic transducers are arranged and aligned such that the first ultrasonic transducer is capable of emitting the first measurement signal oblique to the flow direction of the fluid to the second ultrasonic transducer and is capable of receiving the second measurement signal emitted by the second ultrasonic transducer oblique to the flow direction.

3. The method according to claim 1, wherein a flow rate of the fluid through the pipe is determined from the transit time differences between the first measurement signals and the second measurement signals.

4. The method according to claim 1, in which the ultrasonic measuring device is a clamping device, and the pipe is clamped in the ultrasonic measuring device.

5. The method according to claim 1, wherein the determination of the fraction of the disperse gas phase is updated at regular intervals or continuously.

6. The method according to claim 3, in which a corrected mean value for the flow rate is determined by the fraction of the disperse gas phase.

7. The method according to claim 6, in which the corrected mean value indicates the flow rate of the fluid without the disperse gas phase.

8. The method according to claim 1, in which the scattering parameter is a variance of the individual values with respect to the mean value.

9. The method according to claim 1, wherein the change in the scattering parameter in dependence on the fraction of the disperse gas phase at a constant mean value for the transit time difference is described by a linear determination function.

10. The method according to claim 9, in which the linear determination function is defined by two linear coefficients and each linear coefficient is determined from a polynomial function with a variable that is the mean value for the transit time difference.

11. The method according to claim 1, wherein the change in the scattering parameter in dependence on the fraction of the disperse gas phase at a constant mean value for the transit time difference is stored in a lookup table in the storage and evaluation unit.

12. The method according to claim 1, wherein first the fraction of the disperse gas phase is determined, and from this a modified fraction of the disperse gas phase is determined by applying a smoothing factor.

13. The method according to claim 12, wherein the smoothing factor is calculated with a polynomial function with a variable that is the mean value for the transit time difference.

14. The method according to claim 1, wherein the disperse gas phase includes gas bubbles and the fraction of the disperse gas phase is a volume fraction of gas bubbles in a liquid.

15. The method according to claim 1, wherein each transit time difference is converted into a value for a flow rate of the fluid through the pipe and the fraction of the disperse gas phase is determined by the values for the flow rate.

16. The method according to claim 1, wherein individual values for the transit time difference or a mean value over several individual values are transformed into individual values for a flow rate of the fluid or into a mean value for the flow rate, and steps h) and i) are carried out with the individual values for the flow rate or the mean value for the flow rate.

17. The method according to claim 16, wherein the flow rate of the fluid through the pipe is determined from the transit time differences between the first measurement signals and the second measurement signals.

18. The method according to claim 16, wherein each transit time difference is converted into a value for the flow rate of the fluid through the pipe and the fraction of the disperse gas phase is determined by the values for the flow rate.
